(19) United States
(12) Patent Application Publication
(10) Pub. No.: US 2008/0172445 A1
(43) Pub. Date: Jul. 17, 2008

(54) Method and System For Increasing Popularity of Content Items Shared Over Peer-to-Peer Networks

(75) Inventors: Alexander Zaidelson, Rehovot (IL); Ilya Pashkovsky, Rishon Le Zion (IL); Jhanna Lazovsky, Petach Tikvah (IL); Alexander Lazovsky, Petach Tikvah (IL); Camuel Gilyadov, Petach Tikvah (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: NETBARRAGE, Petach Tikvah (IL)

(21) Appl. No.: 11/994,889

(22) PCT Filed: Jul. 6, 2006
(86) PCT No.: PCT/IL2006/000789

§ 371 Date: Jan. 7, 2008

Related U.S. Application Data
(60) Provisional application No. 60/595,486, filed on Jul. 9, 2005.

(51) Int. Cl. G06F 15/16

(52) U.S. Cl. 709/201

(57) ABSTRACT

The present invention relates to a method and system for increasing popularity of one or more content items shared over a peer-to-peer network, comprising: (a) a central server for receiving from an operator terminal by means of a user interface software component a list of said one or more content items to be shared over said peer-to-peer network; and (b) one or more virtual clients servers for communicating with said central server, receiving said list, and increasing popularity of said one or more content items at said peer-to-peer network by creating at least one thousand virtual clients which form a statistical weight sufficient to affect the overall popularity of said one or more content items, each of said virtual clients sharing or pretending to share said one or more content items.

### FIELD OF THE INVENTION

The present invention relates to peer-to-peer networks. More particularly, the invention relates to a method and system for increasing popularity and availability of content items shared over peer-to-peer networks.

### BACKGROUND OF THE INVENTION

Throughout this specification, the following definitions are employed:

Peer-To-Peer Network (or P2P): is a computer network in which each workstation has equivalent capabilities and responsibilities. This differs from client/server conventional networks, in which some computers are dedicated to serving the others. Peer-to-peer networks are generally simpler, but they usually do not offer the same performance under heavy loads. P2P computer network relies on the computational power and bandwidth of the participants in the network rather than on a relatively low number of servers, as conventional networks do. P2P networks are useful for many purposes, such as sharing content files containing audio, video and any other types of data in a digital format.

Socket: A socket, such as the Internet socket is a software abstraction, designed to provide a standard Application Programming Interface (API) for sending and receiving data across a computer network. Sockets are designed to accommodate virtually any networking protocol, though in practice are used mostly for the internet suite of protocols (such as TCP/IP). Sockets are implemented in many different computer languages and for most operating systems.

In the last decade, peer-to-peer file sharing has become a major application of broadband home network connections. Nowadays, it is estimated that more than 60 million Americans use various peer-to-peer file sharing software, and more than 400 million people worldwide do so. There are a number of conventional peer-to-peer network protocols, such as BitTorrent, ED2K, FastTrack, Gnutella, Overnet, etc. Each of said protocols has corresponding peer-to-peer file-sharing software that uses it. For example, FastTrack is used by Kazaa™ and Kazaa Lite™ software, ED2K is used by eMule and eDonkey™ software, etc. The P2P file-sharing networks are anonymous in terms of their users; therefore, registering and joining the network does not require identification. The P2P network automatically assigns each new user with a unique user identifier, and as a result, the new user becomes a part of the corresponding P2P network. In addition, each file within each P2P network is also assigned with its unique file identifier, which is typically a hash code calculated by implementing a hash function (such as SHA-1 (Secure Hash Algorithm-1), MD5 (Message-Digest algorithm 5), etc.) on the file content. The file identifiers are usually generated by means of dedicated hash functions (generally, a hash function is used for examining the input data and producing an output of a fixed length code).

As various research shows, at least 80% of all P2P traffic is generated by at most 20% of files transferred by means of peer-to-peer networks. In most peer-to-peer file-sharing networks, the network addresses related to computers that share and/or download files over a P2P network are available to everyone connected to the network. Usually, when a user begins downloading a file, the file is automatically shared with other users over the network, even when the user does not yet have the file in full. Furthermore, the conventional search facilities of most P2P file-sharing networks make it possible for any user to find other users, who either are sharing the full file or are in process of downloading that file and sharing parts thereof. The shared files can represent various data contents, such as music (songs), movies, pictures, and any other types of electronic documents or media.

Most of P2P networks provide conventional search facilities to P2P users (such as the SuperNode in the FastTrack P2P network). Such facilities allow users to insert keywords (search criteria) and receive a list of search results that answer the search criteria. The list of search results contains names of shared content items (such as music “.mp3” files, movie files, image files, etc.). Upon receiving the list of search results, the user can select for downloading one or more specific content items from said list. For each content item, the search results usually comprise the following data:
the number of P2P users that share the content item;
percentage of P2P users that have the file in full; it defines completeness of the content item;
additional data related to the content item (such as the file size of the content item, timestamp of the content item, etc.).

When searching for a specific content item, users usually get tens or hundreds of search results that answer their search criteria. Usually, the users download and acquire content items (files) within the received search results that have higher popularity (and availability) and higher completeness. The more popular content items are located higher in a list of search results in P2P program window presented on a P2P user's computer screen, and the P2P user usually tends to download content items that he sees on the screen without scrolling it down. The popularity and availability of content items is defined by a number of P2P users that share said items. The larger the number of sharers, the more popular and available the shared item (file). The more popular file is downloaded faster onto a P2P user's computer, since said file is spread among more nodes (peers) within the P2P network. Each file is usually downloaded in portions, therefore if a P2P user uploading said file switches off his computer, then another user downloading said file can download it from another user. In addition, each user has limited upload bandwidth, therefore the more users download said file from said user, the slower the download speed is. Therefore, there is a great advantage in downloading the most popular file. It is supposed, for example, that a P2P user enters a query for keywords “Britney Spears Do Something” into his eMule P2P dedicated program (installed on his computer). Then, in response, he receives a list of search results comprising 150 different files answering his search criteria. Each file has different availability. The user, desiring to get the file faster, most likely will decide to download the file that has the highest popularity and availability (places on the top of said list).

Many copyright-protected files, such as songs, movies, software, etc. are shared over P2P networks for free. Therefore, content items providers (companies, individuals) that are promoting and retailing legitimate content items have to insure that their items are displayed on the top of search results lists presented to P2P users, when searching the P2P network according to predefined search criteria. In addition, said providers may wish to suppress distribution of undesired and copyright-infringing content items over P2P networks by providing items with meaningless contents (serving as decoys) and insuring that these items have high popularity.

Therefore, it is an object of the present invention to provide a method and system for increasing popularity and availability of content items shared over peer-to-peer networks.

It is another object of the present invention to provide a method and system for generating similar content items, which are slightly different one from another. By increasing popularity and availability of such similar content items, the P2P user (when searching the P2P network) is presented with said items on his computer screen, and as a result, the probability that he will download one of said items is increased. Therefore, the more similar content items are generated, the greater is the exposure of said items to P2P users and the greater is the probability that said user will download one or more said items.

It is still another object of the present invention to provide a method and system for promoting and retailing of legitimate content items over P2P networks by increasing their popularity and availability, and as a result increasing their exposure to P2P users.

It is still another object of the present invention to provide a method and system for suppressing distribution of undesired and copyright-infringing content items over P2P networks.

It is still a further object of the present invention to provide a method and system, which are relatively inexpensive.

Other objects and advantages of the invention will become apparent as the description proceeds.

### SUMMARY OF THE INVENTION

The present invention relates to a method and system for increasing popularity and availability of content items shared over peer-to-peer networks.

The system for increasing popularity of one or more content items shared over a peer-to-peer network comprises: (a) a central server for receiving from an operator terminal by means of a user interface software component a list of said one or more content items to be shared over said peer-to-peer network; and (b) one or more virtual clients servers for communicating with said central server, receiving said list, and increasing popularity of said one or more content items at said peer-to-peer network by creating at least one thousand virtual clients which form a statistical weight sufficient to affect the overall popularity of said one or more content items, each of said virtual clients sharing or pretending to share said one or more content items.

Optionally, the central server is provided within the virtual clients server.

Preferably, the operator terminal further provides to the central server one or more of the following: (a) a number of virtual clients to be created for sharing each content item within the list; (b) one file for each content item within said list; (c) identifiers of the files; and (d) metadata relating to said each content item.

Preferably, the central server further comprises a communication software component for communicating with the virtual clients server.

Preferably, the virtual clients server further comprises a geographic locations detection software component for analyzing network addresses of peer-to-peer users who requested to download or downloaded the one or more content items from at least one virtual client, and determining the corresponding geographic locations of said users.

Preferably, the central server further receives from the virtual clients server statistical data relating to the process of sharing the one or more content items, said data comprising one or more of the following: (a) a number of peer-to-peer users who downloaded or requested to download said one or more content items; (b) nicknames of said peer-to-peer users; (c) timestamps; and (d) unique identifiers of said peer-to-peer users.

Preferably, the central server further receives from the virtual clients server geographic locations of the peer-to-peer users who requested to download or downloaded the one or more content items, for statistical purposes.

Preferably, the central server further comprises a search software component for connecting to the peer-to-peer network, searching said network according to a predefined search criteria and determining a number of users sharing the most popular item answering said search criteria.

Preferably, the virtual clients server further receives from said search software component said number of users sharing the most popular content item, and further creates a number of virtual clients for sharing the corresponding content item, said number of virtual clients larger or equal to said number of users.

Preferably, the central server further comprises a database for storing the list of the one or more content items along with additional data provided by the operator terminal and virtual clients server.

Preferably, the central server further comprises a reporting software component for querying the database and generating one or more reports based on the data stored within said database.

Preferably, the virtual clients server further comprises a communication manager software component for communicating with the central server.

Preferably, the virtual clients server further comprises a task manager software component for creating tasks, according to data provided by the communication manager, said task manager maintaining a list of tasks and creating one or more virtual clients for serving each task.

Preferably, the virtual clients server further comprises a tasks software component for holding data related to each task.

Preferably, the virtual clients server further comprises a state machines software component for defining the behavior of a virtual client in each peer-to-peer network.

Preferably, the virtual clients server further comprises a virtual clients software component for handling the virtual clients that share or pretend to share the one or more content items over the peer-to-peer network.

Preferably, each virtual client is connected to a corresponding state machine and operates at any given time according to a corresponding state of said state machine.

Preferably, the virtual clients server further comprises a connection manager software component for providing a network address to each virtual client from a pool of outgoing network addresses, said pool provided within said virtual clients server and holding a list of available network addresses.

Preferably, the virtual clients server further comprises a configuration manager software component for reading configuration of a peer-to-peer protocol from a protocols configuration software component which holds necessary configuration parameters for each peer-to-peer network, said configuration manager software component conveys said configuration to the connection manager.

Preferably, the virtual clients server further comprises a configuration repository for holding the overall configuration of said virtual clients server.

Preferably, the virtual clients server further comprises a networking layer for providing network communication services for said virtual clients server.

The method for increasing popularity of one or more content items shared over a peer-to-peer network comprises: (a) providing to a central server by means of an operator terminal using a user interface software component a list of said one or more content items to be shared over said peer-to-peer network; and (b) transferring said list from said central server to one or more virtual clients servers for increasing popularity of said one or more content items at said peer-to-peer network by creating at least one thousand virtual clients which form a statistical weight sufficient to affect the overall popularity of said one or more content items, each of said virtual clients sharing or pretending to share said one or more content items.

Preferably, the method further comprises providing the central server within the virtual clients server.

Preferably, the method further comprises providing to the central server by means of the operator terminal one or more of the following: (a) a number of virtual clients to be created for sharing each content item within the list; (b) one file for each content item within said list; (c) identifiers of the files; and (d) metadata relating to said each content item.

Preferably, the method further comprises providing the central server with a communication software component for communicating with the virtual clients server.

Preferably, the method further comprises analyzing network addresses of peer-to-peer users who requested to download or downloaded the one or more content items from at least one virtual client, and determining the corresponding geographic locations of said users by means of a geographic locations detection software component provided within the virtual clients server.

Preferably, the method further comprises providing the central server by means of the virtual clients server with statistical data relating to the process of sharing the one or more content items, said data comprising one or more of the following: (a) a number of peer-to-peer users who downloaded or requested to download said one or more content items; (b) nicknames of said peer-to-peer users; (c) timestamps; and (d) unique identifiers of said peer-to-peer users.

Preferably, the method further comprises providing the central server by means of the virtual clients server with geographic locations of the peer-to-peer users who requested to download or downloaded the one or more content items, for statistical purposes.

Preferably, the method further comprises providing the central server with a search software component for connecting to the peer-to-peer network, searching said network according to a predefined search criteria and determining a number of users sharing the most popular item answering said search criteria.

Preferably, the method further comprises providing the virtual clients server by means of said search software component with said number of users sharing the most popular content item, and further creating a number of virtual clients for sharing the corresponding content item, said number of virtual clients larger or equal to said number of users.

Preferably, the method further comprises providing the central server with a database for storing the list of the one or more content items along with additional data provided by the operator terminal and virtual clients server.

Preferably, the method further comprises querying the database by means of a reporting software component provided within the central server and generating one or more reports based on the data stored within said database.

### BRIEF DESCRIPTION OF THE DRAWINGS

In the drawings:

FIG. 1 is a schematic illustration of a system for increasing popularity of content items shared over peer-to-peer networks, according to an embodiment of the present invention;

FIG. 2A is a flow chart of a method for increasing popularity of content items shared over peer-to-peer networks, according to an embodiment of the present invention;

FIG. 2B is a flow chart of a method for creating a plurality of similar content items, according to an embodiment of the present invention;

FIGS. 2C and 2D illustrate sample lists of search results presented to a peer-to-peer user searching a peer-to-peer network for a content item, according to an embodiment of the present invention;

FIG. 3 is a schematic illustration of Central Server architecture, according to an embodiment of the present invention;

FIG. 4A is a schematic illustration of a Virtual Clients Server architecture, according to an embodiment of the present invention; and

FIG. 4B is a flow chart of the Virtual Clients Server operation, according to an embodiment of the present invention.

### DETAILED DESCRIPTION OF THE PREFERRED EMBODIMENTS

As said, the present invention provides a method and system for increasing popularity and availability of content items (such as music files, movie files, image files, etc.) shared over peer-to-peer networks. As will be discussed in more detail, the system of the invention achieves this goal by the creation and introduction into the P2P network a plurality of virtual P2P users (clients) (such as creation thousands, tens or hundreds thousands virtual clients). The term “virtual” is used herein to indicate that the user, which the system creates, is not a conventional user, i.e., it is not a human user. On the other hand, each “virtual client” is a machine created and operated user, which behaves like a regular human user, and is therefore undistinguishable by external entities from said human users of the network. When plurality of virtual clients are introduced into the P2P network, and when, for example, all of said plurality of virtual clients share a same content item over said P2P network, such content item will appear to have high availability to other human users (leading to increase of popularity of this content item), which will induce them to download this item. In most existing peer-to-peer file-sharing programs, the more popular (available) a content item is, the higher it is displayed in a search result list presented to the P2P user searching the P2P network, according to predefined search criteria.

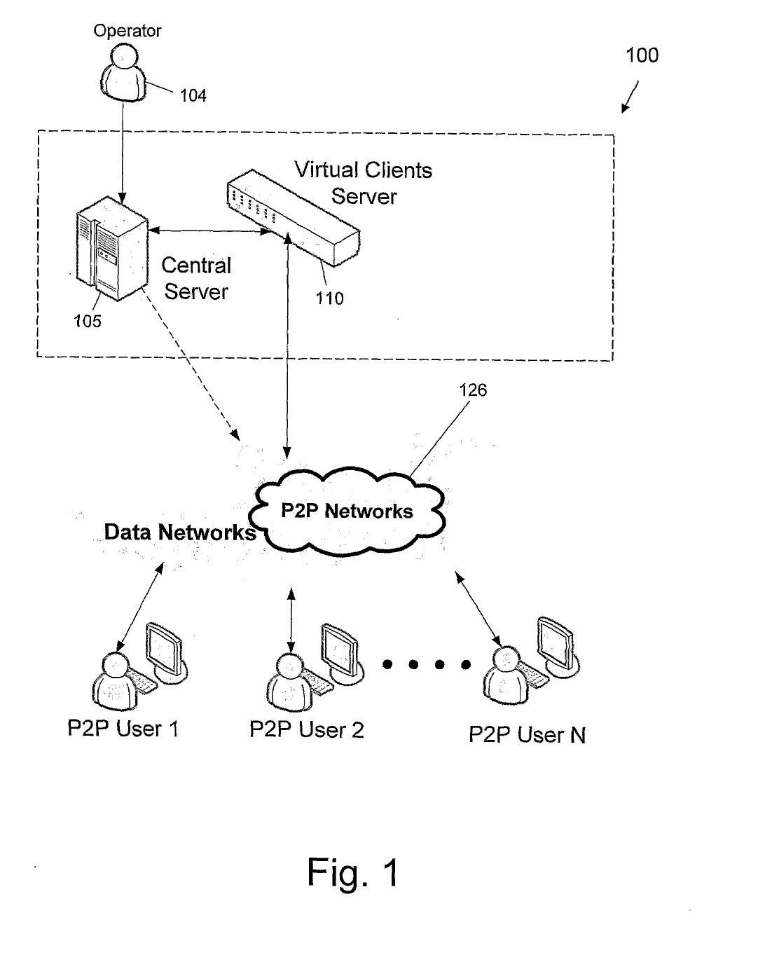

FIG. 1 is a schematic illustration of a system 100 for increasing popularity of content items shared over peer-to-peer networks, according to an embodiment of the present invention. The system comprises a Central Server 105 for receiving from an Operator terminal 104 a list of content items (along with additional data) to be shared over a P2P network, for storing the data received from said Operator terminal 104 in a database, and for providing to said Operator terminal 104 statistical data related to the progress of sharing said content items (such as a number of P2P users that downloaded said content items); and Virtual Clients Server 110 for creating a plurality of virtual clients for sharing said content items over the P2P network. As said, the more virtual clients are created for sharing a content item, the higher the popularity (availability) of said content item is and the higher said content item is displayed in a list of search results presented to the P2P user when searching the P2P network, according to his search criteria. In turn, this leads to inducing the P2P user to download the item.

Operator 104 enters into Central Server 105 a list of content items to be shared over the P2P network. For each item, Operator 104 provides the following data:
a name of the content item (for example, “Cool Winter Song”);
a corresponding binary file to be shared under that name (ex. a DRM-protected (Digital Rights Management) music file);
a target number of “sources” (virtual clients) to be created, i.e. the number of virtual clients to be created for connecting to the P2P network and sharing the content item. This number can be selected to be larger or equal to a number of users over the P2P network sharing similar content items. The number of said overall sources can be determined by querying the P2P network using predefined search criteria, such as the “Cool Winter Song”, and then determining the maximal number of P2P users sharing each content item (file) within the search result list provided according to said search criteria. For example, if the most popular file answering said search criteria is shared by 15,000 users, then the number of virtual clients to be created should be greater or equal to 15,000. For creating such large number of virtual clients, a plurality of Virtual Clients Servers 110 can be required.
an unique identifier of the file; and
metadata (such as a song composer, movie producer, song/movie/software category or genre, singer, actor, file type, file size, file extension, etc.) as may be required by the P2P network.

The specified content item may be either a new item, or an item that is already shared over the peer-to-peer network. After receiving the data from Operator 104, Central Server 105 transfers it to Virtual Clients Server 110. Virtual Clients Server 110 creates a plurality of virtual clients for connecting to the search facility of the corresponding P2P network, such as to the SuperNode in the FastTrack P2P network, and for pretending to be conventional network clients (users). Then, each virtual client presents to all users connected to the P2P network what content items it shares. As a P2P user searches, for example, for “Cool Winter Song” by means of dedicated P2P software, the search facility presents relevant content items (shared by virtual clients and other P2P users) on his computer screen.

According to an embodiment of the present invention, virtual clients created by Virtual Clients Server 110 show to P2P users by means of P2P search facilities of corresponding P2P networks that they share one or more content items, when actually they only pretend to do so. When creating a plurality of virtual clients pretending to share a specific content item, the popularity of said content item increases similarly to the case when the virtual clients actually share said item. Thus, the P2P users are induced to download the content item. However, a provider of system 100 may wish to save computer resources or transmission bandwidth of said system 100, and not enable virtual clients to actually share the content item. In this case, these virtual clients serve as advertisers for the content item, increasing its popularity and availability over the P2P network, without actually sharing it.

According to another embodiment of the present invention, all virtual clients created by Virtual Clients Server 110 show to P2P users by means of P2P search facilities that they share one or more content items, and they actually do so. In this case, the virtual clients serve as content sharers. It should be noted that each virtual client can serve both as an advertiser and as a sharer.

When the P2P user wishes to download a specific content item, the search facility of the P2P network provides his P2P program (installed on his computer for enabling various P2P activities) with addresses of corresponding virtual clients, which are the sources of said content item over the P2P network. Then, one or more virtual clients receive the user's request to download the item, and upload the required item to said user's computer (if they are actual sharers of said item and not just advertisers).

According to an embodiment of the present invention, a plurality of similar content items is generated and then shared by means of virtual clients over the P2P network. Each content item differs one from another by a very small portion of content, which is transparent to the P2P user and has no effect on the file presentation. For example, several bytes can be added at the end of the content item, such as the “Cool Winter Song.mp3” file. Subsequently, when P2P user searches the P2P network, he receives multiple similar content items in his search result list, according to his search criteria. Thus, the P2P user is induced to download one or more content items within the plurality of multiple items provided by virtual clients, rather than to download one or more content items from other sources. It should be noted that generating a plurality of similar content items can be done in peer-to-peer networks such as the ED2K network, wherein each file is identified by its unique identifier assigned by means of a identifier-generating function, such as a hash function (which is run on the content of said each file). Adding several different bytes to the end of each copy of the file will result in that each said copy will have different hash code, and thus each copy will appear as a different content item over the P2P network.

It should be noted that content items within the plurality of multiple items presented to the user, can also have slightly different file names. The names can be similar (for example, they can comprise the name of the corresponding content item, such as a song) so that when a P2P user queries the P2P network, then multiple file names that answer his search criteria will be presented to said user within the search results list. On the other hand, if the file names are absolutely the same, it may be obvious to the P2P users that all multiple content items are provided by the same system (such as system 100).

In order to have the multiple content items to appear with different file names, almost-identical copies of the file representing the content item should be created as explained above. For creating such copies of the original file, the following steps should be carried out:
a. the original file is loaded into the memory of a corresponding software component within Virtual Clients Server 110;
b. the content of the original file is slightly modified (for example, the last four bytes at the end of the file are set to a pseudorandom value);
c. the value of modified portion of the file (such as the value of the last four bytes, if the last four bytes were modified) is saved for a future use—when the file is requested to be downloaded by a P2P user, the exact content of the file has to be known and provided to the user.
d. a file identifier-generating function (such as a hash function) is run on the content of the modified file, and it generates an identifier of said file;
e. the name of each file is slightly altered. For example, the “Cool Winter Song” file can be changed to “Cool_Winter_Song” file.

It should be noted that steps “b” to “d” above, should be performed in P2P networks (for example, in the ED2K network), wherein each file is identified by its unique identifier assigned by means of a identifier-generating function, such as a hash function (which is run on the content of said each file).

Because of content items multiplication, a P2P user who searches for “Cool Winter Song” over the P2P network gets multiple files with similar names in his search results list. The content of each file is slightly different, and thus each file has a different file identifier. It should be noted that in networks such as the ED2K network wherein each file is identified by its unique identifier, the name of each file does not influence the generation of the file identifier, and therefore files having different names but same content, would still have the same file identifier for each of them, and would appear as exactly the same content item within the search results list.

If a sufficient number of such multiple content items is generated and provided by virtual clients of system 100, then each P2P user searching for the content item will see on his computer screen (in the P2P program window) only items shared by system 100.

According to an embodiment of the present invention, system 100 comprises more than one Virtual Clients Server 110. A reason for providing more than one Virtual Clients Servers 110 can be a desire to split computational resources and bandwidth usage among several Virtual Clients Servers 110. It should be noted that most of nodes (peers) over the peer-to-peer network usually do not allow connection of more than a certain number of users (such as 10 users from a single IP (Internet Protocol address). Therefore, a large number of IP addresses should be available for each Virtual Clients Server 110. IP addresses can be provided to Virtual Clients Server 110 by means of an Internet Service Provider (ISP) or through one or more proxy servers.

It should be noted that each network address can be the TCP/IP (Transmission Control Protocol/Internet Protocol) address or UDP (User Datagram Protocol) address, which comprises an IP (Internet Protocol) number and a network port number. In addition, it should be noted that Virtual Clients Server 110 and Central Server 105 are implemented by software and/or by hardware.

According to an embodiment of the present invention, Central Server 105 is provided within Virtual Clients Server 110.

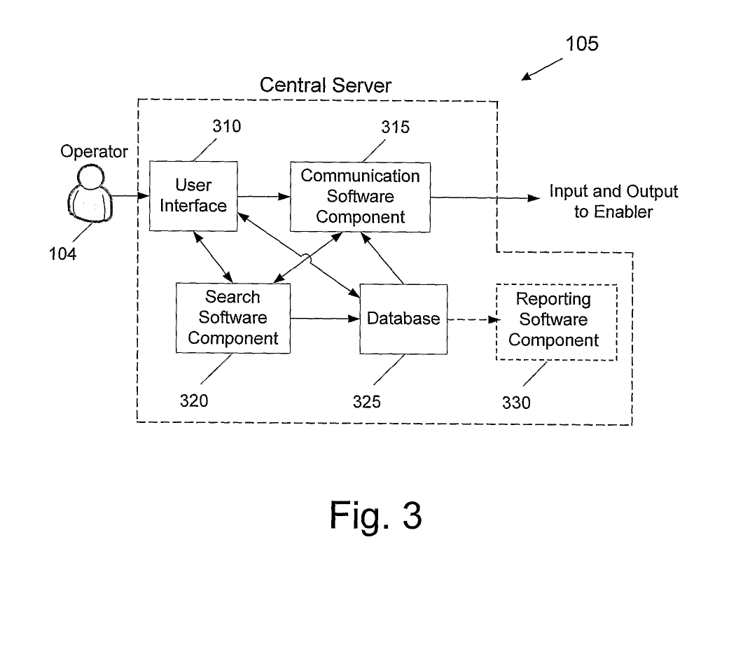

According to an embodiment of the present invention, Central Server 105 comprises a Search software component 320 (FIG. 3). For each content item within the list of content items provided by Operator 104, said Search component 320 determines a number of overall sources over the P2P network that share similar content item, by connecting to said P2P network and querying the search facilities of said P2P network for the corresponding content item by using predefined search keywords, such as the “Cool Winter Song”. In response to this query, Search component 320 receives a list of content items (files) that answer said search criteria and corresponding sources that share said files. Each content item within said list can be shared by different number sources. The more sources that share the content item, the more popular the content item is. The number of virtual clients to be created by Virtual Clients Server 110 can be larger or equal to the number of sources that share the most popular content item within said list.

It should be noted that Search software component 320 can be provided within the Virtual Clients Server 110.

It should be noted that according to an embodiment of the present invention, Operator 104 wishes the content item to appear on the top of the search results list for a general query, for example for the name of a musical genre such as “Jazz”. In this case, Operator 104 determines (either by means of Search software component 320 or by using dedicated P2P software, searching the P2P network according to keyword “Jazz”) a number of sources N sharing the most popular item answering his search criteria (comprising the word “Jazz” in its name). Then, Operator 104 instructs Virtual Clients Server 110 by means of Central Server 105 to create at least N virtual clients for sharing corresponding items. Each content item to be shared by virtual client should comprise the word “Jazz” in its name. As a result, a P2P user who looks for the jazz music and enters the word “Jazz” into the search window of his P2P dedicated software, will receive said content items shared by said N virtual clients on the top of the search result list returned by the P2P search facility of the P2P network.

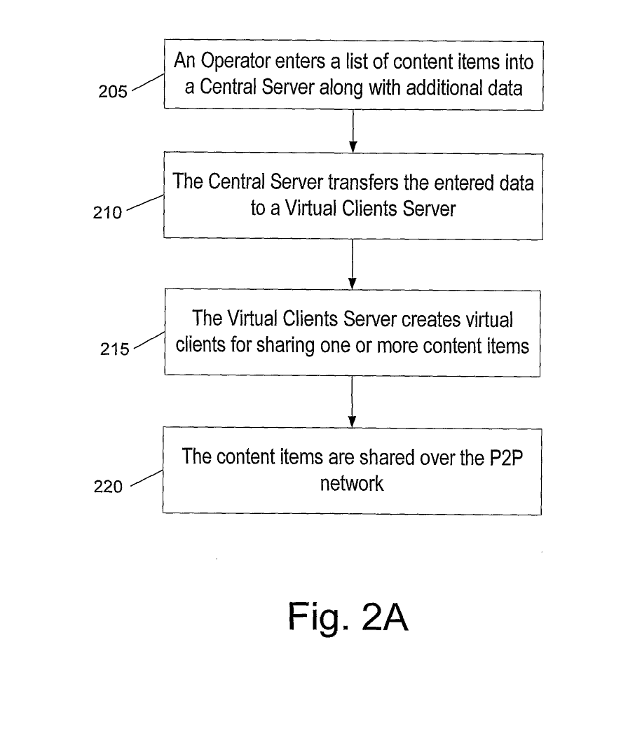

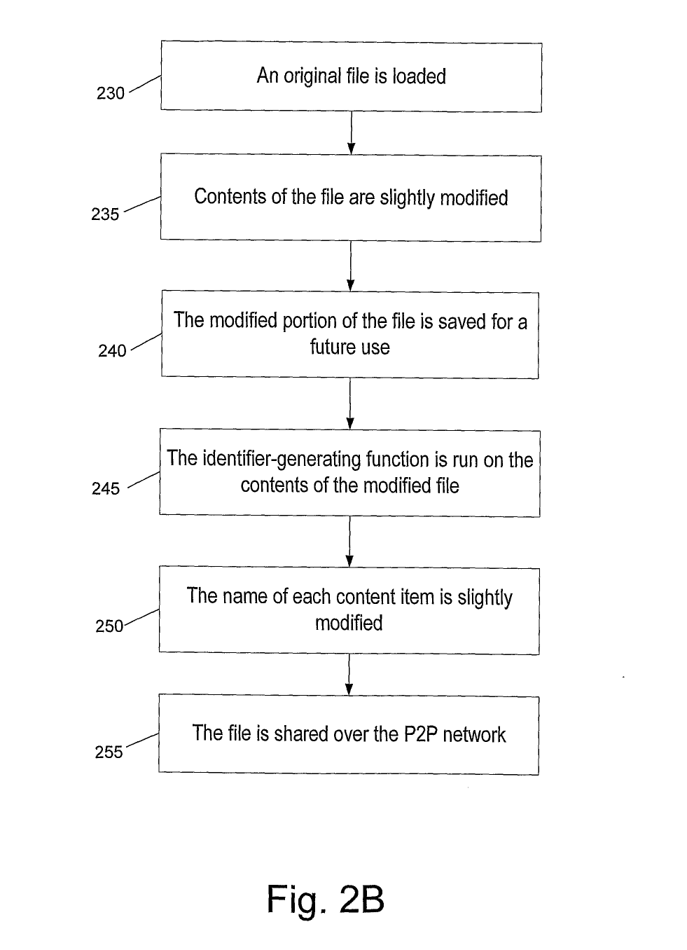

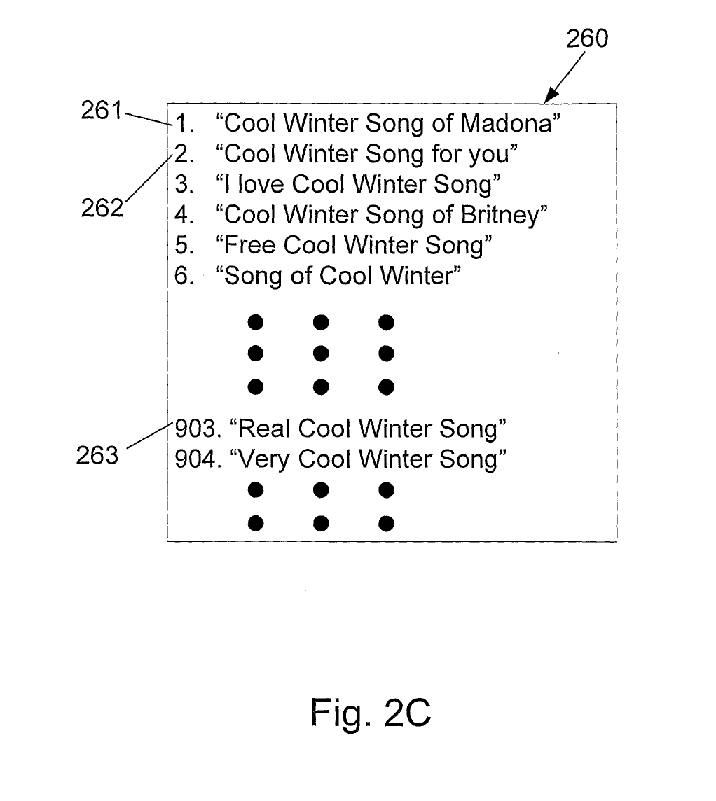

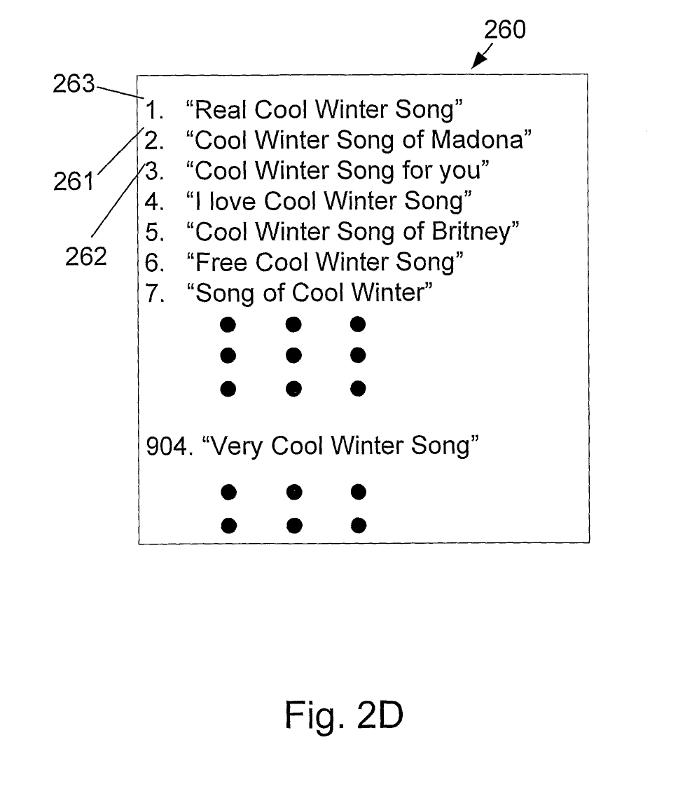

FIG. 2A is a flow chart of a method for increasing popularity of content items shared over peer-to-peer networks, according to an embodiment of the present invention. At step 205, Operator 104 (FIG. 1) enters a list of content items to be shared over the peer-to-peer network into Central Server 105 (FIG. 1) by using a conventional User Interface. For each item within the list, the following additional data is provided by Operator 104:
a name of the content item (for example, “Cool Winter Song”);
a corresponding binary file to be shared under that name (ex. a DRM-protected (Digital Rights Management) file);
a target number of “sources” (virtual clients) to be created, i.e. the number of virtual clients to be created for connecting to the P2P network and sharing the content item. The number of said overall sources can be determined by querying the P2P network using predefined search criteria, such as the “Cool Winter Song”, and then determining the maximal number of P2P users sharing each content item (file) within the search result list provided according to said search criteria.
an unique identifier of the file; and
metadata (such as a song composer, movie producer, song/movie/software category or genre, singer, actor, file type, file size, file extension, etc.) as may be required by the P2P network.

At step 210, after receiving the data from Operator 104, Central Server 105 transfers it to Virtual Clients Server 110. Then at step 215, Virtual Clients Server 110 creates a plurality of virtual clients for connecting to the search facility of the corresponding P2P network, such as to the SuperNode in the FastTrack P2P network, and for pretending to be conventional network clients (users). At step 220, each virtual client starts sharing (or starts pretending to share) the corresponding content item, and shows to all users connected to the P2P network what content items it shares. As the P2P users search, for example, for “Cool Winter Song”, the search facility of the P2P network presents to said user the content items shared by the plurality of virtual clients, for example, by thousands virtual clients which form a statistical weight sufficient to affect the overall popularity of said content items. When the P2P user wishes to download the content item, the search facility provides his P2P program (installed on his computer for enabling various P2P activities) with addresses of corresponding virtual clients, which are the sources of said content item over the P2P network. Then, one or more virtual clients receive the user's request to download the item, and upload the required item to user's computer.

FIG. 2B is a flow chart of a method for creating a plurality of similar content items, according to an embodiment of the present invention. At step 230, the original file representing a content item is loaded into the memory of a corresponding software component within Virtual Clients Server 110. Then at step 235, the content of the original file is slightly modified (for example, the last four bytes at the end of the file are set to a pseudorandom value). At step 240, the modified portion of the file (such as the value of the last four bytes) is saved for a future use—when the file is requested for downloading by a P2P user, the exact content of the file has to be known. A file identifier-generating function (such as a hash function) is run on the content of the modified file at step 245, and it generates an identifier of said file. At step 250, the name of each file is slightly modified. For example, the “Cool Winter Song.mp3” file can be changed to “Cool_Winter_Song.mp3” file. Then at step 255, the file is shared over the P2P network, being identified by its name and its unique identifier.

FIG. 2C illustrates a sample list of search results presented to a P2P user searching a P2P network for a content item, according to an embodiment of the present invention. It is supposed that for searching said P2P network, the user enters the keywords “Cool”, “Winter” and “Song” into a corresponding search field of his dedicated P2P software. In response, the user receives a list of search results 260 comprising content items 261, 262, 263, etc. that answer his search criteria. The higher a content item is placed within said list 260, the more popular it is (the more sources share this item). For example, it is supposed that content item 261 “Cool Winter Song by Madonna” is shared by 2,000 sources (users). Also, it is supposed that Operator 104 (FIG. 1) wishes to increase popularity of content item 263 named “Real Cool Winter Song”, which is located on 908-th place within said list 260. Operator 104 enters the name (“Real Cool Winter Song”) of said content item into Central Server 105 (FIG. 1). Along with said name, Operator enters additional data, such as a corresponding binary file to be shared under said name, a target number of virtual clients to be created by means of Virtual Clients Server 110 (FIG. 1) for sharing or pretending to share said file, a unique identifier of said file, metadata (such as a song composer, song category or genre, singer, file type, file size, file extension, etc.). The above target number of virtual clients should be (for this example) larger or equal to 2,000, and it is supposed that the target number is 2,010 virtual clients. Then, all the above data is transferred to Virtual Clients Server 110, which creates 2,010 virtual clients. After that, said virtual clients start sharing or start pretending to share said content item 263, and as a result, the “Real Cool Winter Song” item becomes most popular, and is located in the 1-st place within the search result list 260, as shown on FIG. 2D. Each P2P user searching the P2P network by using “Cool”, “Winter” and “Song” keywords is now presented with search result list 260, wherein the “Real Cool Winter Song” item is in the 1-st place that induces him to download this item. It should be noted that the number of virtual clients can be further updated. If after creating 2,010 virtual clients, it was further determined by means of Search software component 320 (FIG. 3), for example, that there are 2,020 P2P users that share “Cool Winter Song by Madonna” (not including the virtual clients), then 11 additional virtual clients should be created. Then, the number of virtual clients (2021) would be greater than the number of other sources sharing said file, and therefore the “Real Cool Winter Song” item would be now in the 1-st place.

FIG. 3 is a schematic illustration of Central Server 105 architecture, according to an embodiment of the present invention. Central Server 105 comprises: a User Interface software component 310 for receiving from Operator 104 a list of content items (along with additional data) to be shared over the peer-to-peer network and for displaying to said Operator 104 data related to the progress of sharing said content items (such as a number of P2P users that downloaded said content items, a number of virtual clients created by Virtual Clients Server 110 (FIG. 1), etc.); a Database 325 for storing the data provided by said Operator 104 and storing data received from Virtual Clients Server 110 related to the progress of sharing said content items; a Communication software component 315 for communicating with Virtual Clients Server 110, transferring to said Virtual Clients Server 110 the data provided by said Operator 104 and receiving data from Virtual Clients Server 110; optionally, a Search software component 320 for searching the P2P network(s) and determining how many virtual clients should be created by Virtual Clients Server 110 for sharing content items indicated in the list provided by Operator 104; and, optionally, a Reporting software component 330 for querying Database 325 and generating various reports based on data stored within said Database 325.

Operator 104 enters a list of content items to be shared over the P2P network into Central Server 105 by means of User Interface software component 310. For each item within the list, the following additional data is provided by said Operator 104:
a name of the content item (for example, “Cool Winter Song”);
a corresponding binary file to be shared under that name (ex. a DRM-protected (Digital Rights Management) file);
a target number of “sources” (virtual clients) to be created, i.e. the number of virtual clients to be created for connecting to the P2P network and sharing the content item. This number can be selected to be greater or equal to a number of overall sources over the P2P network for similar content items;
a unique identifier of the file; and
metadata (such as a song composer, movie producer, song/movie/software category or genre, singer, actor, file type, file size, file extension, etc.) as may be required by the P2P network.

According to another embodiment of the present invention, for each content item within the list, Search component 320 determines a number of overall sources over the P2P network sharing similar content item, by connecting to said P2P network and querying the search facilities of said P2P network for the corresponding content item by using predefined search criteria, such as the “Cool Winter Song”. Then in response to this query, Search component 320 receives a list of content items (files) that answer said search criteria and a corresponding number of sources that share each one of said files. Each content item within said list can be shared by different sources. The more sources share the content item, the more popular content item is. The number of virtual clients to be created by Virtual Clients Server 110 can be greater or equal to the number of sources that share the most popular content item within said list.

After receiving the above data from Operator 104 and from Search component 320, Communication component 315 transfers it to Virtual Clients Server 110 for further processing. The data provided by Operator 104 is stored within Database 325 along with additional data, such as a number of virtual clients determined by Search component 320, a number of virtual clients that are created by Virtual Clients Server 110, a number of P2P users that requested to download or downloaded content items shared by the virtual clients, etc. Operator 104 further uses Reporting component 330 for creating reports by querying Database 325 and then organizing data stored within said Database 325 according to needs of Operator 104 and/or according to predefined criteria. The reports can comprise statistical monthly/weekly data regarding a number of users that connect to virtual clients for downloading content items during each month/week; geographic location (such as a country, city, neighborhood, etc.) of each user that downloaded or wanted to download one or more items from the virtual clients; nicknames of such users and their additional details (such as their unique identifiers, etc); timestamps, etc.

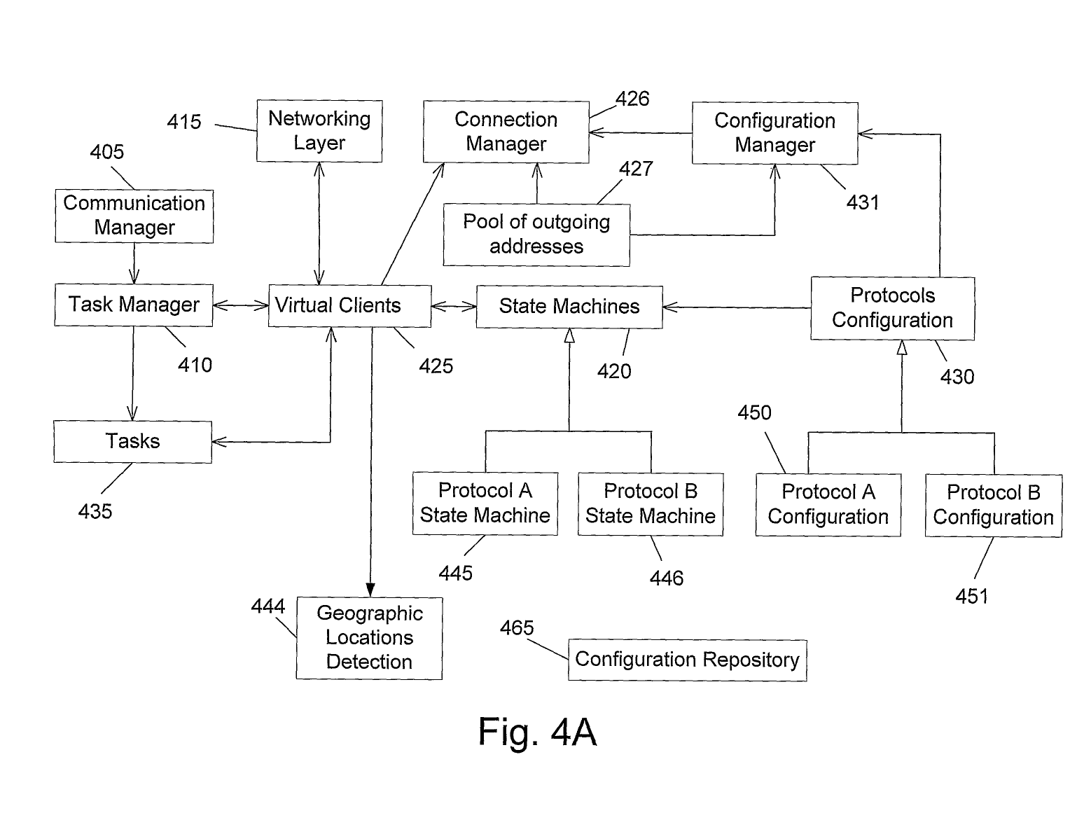

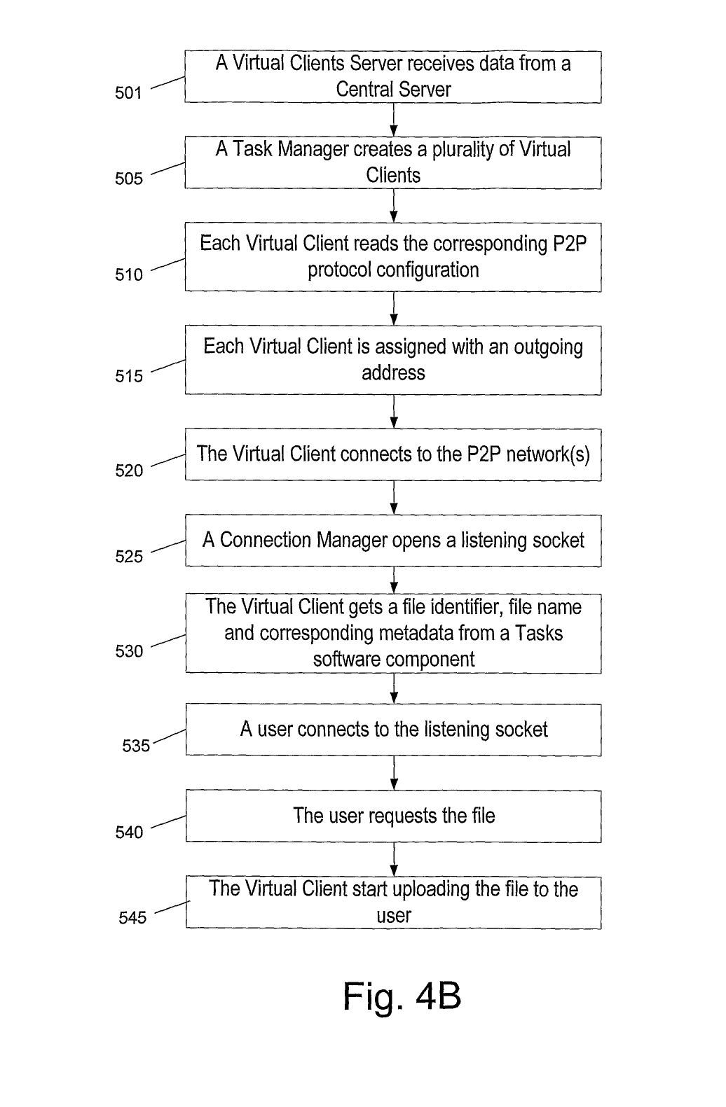

FIG. 4A is a schematic illustration of Virtual Clients Server 110 (FIG. 1A) architecture, according to an embodiment of the present invention. Virtual Clients Server 110 can be implemented, for example, by means of C and C++programming languages on a conventional server with the Linux™ operating system (OS).

Virtual Clients Server 110 comprises the following software components/entities:
(i) a Communication manager software component 405 for communicating with Central Server 105 (FIG. 1) in order to receive from Operator 104 (FIG. 1) a list of content items (along with additional data) to be shared over the P2P network(s).
(ii) a Task Manager software component 410 for creating task entities, according to data provided by Communication manager 405. Task Manager 410 maintains a list of running tasks and creates virtual clients for serving each search task. Each task relates to each content item to be shared over the P2P network. Each virtual client can serve one or more tasks and share one or more content items.
(iii) a Tasks software component 435 for holding data related to each task. Such data can be the name of the corresponding content item, a file to be shared under that name, metadata, unique identifier of the file, the name and/or protocol of a network wherein the corresponding content item should be shared by means of a plurality of virtual clients.
(iv) a Virtual Clients software component 425 for emulating human P2P users connected the P2P network(s) and sharing one or more content items. Each Virtual Client 425 is associated with the corresponding state machine, represented by a State Machines software component 420. For example, if Virtual Client 425 is used for sharing one or more content items over the ED2K network, the ED2K State Machine 420 is assigned to it. The Virtual Client holds all data related to the corresponding state machine and to the corresponding state of the state machine. The Virtual Client, by means of State Machines software component 420, shares one or more content items over the P2P network(s). Then, the Virtual Client transfers to Central Server 105 data related to the sharing process, such as a number of P2P users that downloaded one or more content items; geographic locations of said P2P users' determined by analyzing their network addresses by means of geographic locations detection software component 444; nicknames of said P2P users; timestamps; names of corresponding P2P protocols and/or names of corresponding P2P programs/software running on computers of said P2P users' and any other data. Each Virtual Client is associated with a single socket (such as the TCP/IP socket).
(v) a State Machines software component 420 for abstractly defining the behavior of a virtual client at any given time in each P2P network. State Machines software component 420 comprises a set of functions (“handling functions”) for processing data packets according to a specific P2P protocol and a set of functions (“responding functions”) for creating data packets according to that P2P protocol. Each instance of the State Machines software component 420 is associated with the corresponding Virtual Client 425 and comprises a set of states. Said corresponding Virtual Client 425 moves between these states by means of said handling and responding functions (said Virtual Client 425 operates according to the corresponding state). For example, for State Machine 420 that emulates the behavior of an ED2K client (user), which connects to a conventional ED2K server over the ED2K P2P network, the states can be as follows:
   SRV_CONNECT—the initial state;
   SRV_HELLO_SENT—the connection request is sent to the ED2K server;
   SRV_SHAREDFILES_SENT—the virtual client has sent to the ED2K server a list of files that it shares.
The transition between the “SRV_CONNECT” and “SRV_HELLO_SENT” states is done by means of the “send_hello” function. This function constructs the “HELLO” packet according to ED2K protocol rules and inserts this packet into the buffer (provided within the memory of Enabler 110) for subsequent sending to the corresponding P2P network. After the “HELLO” packet is sent, State Machine 420 moves to the “SRV_HELLO_SENT” state. When the “HELLO_ANSWER” packet arrives, the “hello_answer” handling function called and, after successfully parsing/analyzing the packet, the state machine constructs a “SHAREDFILES” packet, inserts it into the buffer for subsequent sending, and moves to the “SRV_SHAREDFILES_SENT” state. The “SHAREDFILES” packet comprises a list of files that the virtual client wishes to share with other P2P users over the ED2K network.
It should be noted that Protocol A State Machine 445 and Protocol B State Machine 446 relate to State Machines using peer-to-peer Protocol A and B, respectively. Protocol A can be, for example, ED2K protocol and Protocol B can be, for example, BitTorrent protocol.
(vi) a Pool of outgoing network addresses 427 for holding a list of available network addresses, each address to be assigned to each Virtual Client.
(vii) a Connection Manager 426 for managing connecting of P2P users to a plurality of Virtual Clients 425. Connection Manager 426 provides network addresses to a plurality of Virtual Clients 425 from a Pool of outgoing network addresses 427. In addition, Connection Manager 426 keeps a track of closed connections and reopens them upon a need.
(viii) a Configuration Manager software component 431 for reading configuration of a corresponding P2P protocol from a Protocols Configuration software component 430, which is holding necessary configuration parameters for each P2P network, and then transferring said configuration to Connection Manager 426. For example, for using the BitTorrent network, the corresponding configuration parameters can be held, for example, in Protocol A Configuration software component 450, and for using the FastTrack network the corresponding configuration parameters can be held in Protocol B Configuration software component 451.
(ix) a Configuration Repository 465 for storing the overall configuration of Virtual Clients Server 110. For example, Configuration Repository 465 can store the network address of Communication component 315 (FIG. 3) provided within Central Server 105 (FIG. 3) to which Virtual Clients Server 110 needs to connect for receiving data provided by Operator 104 (FIG. 3) and for transferring back the data related to the sharing process (such as a number of users, which downloaded the shared content items). Configuration Repository 465 can use, for example, one or more text files on a hard disk, for storing the configuration of Virtual Clients Server 110.
(x) a geographic locations detection software component 444 for analyzing network addresses related to computers that downloaded or requested to download one or more content items shared by Virtual Clients 425 and determining the geographic location of said computers. For determining the geographic location of the computer (of the P2P user), the software component queries an IP (Internet Protocol) address database, providing a network address related to the computer of the corresponding P2P user. The IP (Internet Protocol) address database can be, for example, the RIPE (Reseaux IP Européens) WHOIS database, which is provided within the Internet. In response, software component 444 receives the required geographic location. According to another embodiment of the present invention, a local copy of the WHOIS database is stored within Virtual Clients Server 110, or within Central Server 105 (FIG. 3). It should be noted that software component 444 can be provided within Virtual Clients Server 110, or it can be provided within Central Server 105 (FIG. 3).
(xi) a Networking Layer 415 for providing network communication services. For example, can_read( ) and can_write( ) functions/calls can be used by Networking Layer 415, when data packets arrive or can be sent, respectively. The can_read( ) function assigns each received packet to a specific Virtual Client 425, and then transfers it to said Virtual Client for parsing/analyzing. On the other hand, the can_write( ) function calls the corresponding Virtual Client for writing data to be sent over the P2P network (as packets), and sends the corresponding packet(s) over said network.

It should be noted that Networking Layer 415 can be asynchronous or synchronous. According to an embodiment of the present invention, the conventional “/dev/epoll I/O (Input/Output) event notification facility” (as described on http://www.opensourcemanuals.org/manual/epoll/) can be used as asynchronous Networking Layer 415. It is assumed, for the example, that each new socket of the corresponding Virtual Client is associated with a socket that is registered with the epoll asynchronous Networking Layer 415. Based on the protocol used by the Virtual Client, the socket is also associated with a corresponding can_read( ) function that performs the initial parsing of the incoming packets by means of the corresponding Virtual Client. For each P2P protocol, a different can_read( ) function can be implemented, for example ed2k_can_read( ) for ED2K protocol. In addition, the mapping between the Virtual Clients and their corresponding sockets can be kept, for example, within the memory of Virtual Clients Server 110.
After Virtual Clients Server 110 is initialized, the Virtual Clients are created along with their corresponding sockets. Then, each corresponding socket is opened for connecting to a corresponding node (such as ED2K server) within the P2P network. After that, the main program loop starts. In the main loop, the epoll asynchronous Networking Layer 415 is queried. In response, a list of sockets that are currently available for writing or reading is returned, and the events array within Virtual Clients Server 110 is filled, comprising data related to each of the available sockets. The data comprises an identifier for each socket (for example, a file descriptor in the Unix-based operating system); and the status of the corresponding socket—available for reading or writing.

FIG. 4B is a flow chart of Virtual Clients Server 110 (FIG. 1A) operation, according to an embodiment of the present invention. At step 501, Virtual Clients Server 110 receives from Central Server 105 a list of content items (along with additional data, such as the metadata of each content item, etc.) to be shared over the P2P network. Task Manager 410 creates tasks for sharing content items within the list. Each task relates to each content item to be shared over the P2P network. Then at step 505, Task Manager 410 (FIG. 3A) creates a plurality of Virtual Clients 425 (FIG. 4A) for serving the tasks and sharing content items within the list. Each virtual client can serve one or more tasks and share one or more content items over one or more P2P networks. Each Virtual Client 425 is associated with the corresponding state machine, represented by a State Machines software component 420. For example, if Virtual Client 425 is used for sharing one or more content items over the ED2K network, the ED2K State Machine 420 is assigned to it. The Virtual Client holds all data related to the corresponding state machine and to the corresponding state of the state machine. At step 510, each Virtual Client 425 reads configuration settings of the P2P protocol(s) related to the corresponding P2P network(s), over which it intends to share one or more content items. The configuration settings are read from Protocols Configuration 430 (FIG. 4A) by means of Configuration Manager 431 (FIG. 4A). Then at step 515, each Connection Manager 431 assigns each Virtual Client 320 with a network address selected from a Pool of outgoing addresses 427 (FIG. 4A). At step 520, each Virtual Client connects to the P2P network, over which it intends to share one or more content items. After that at step 525, Connection Manager 431 opens a listening socket for all or for a portion of network addresses assigned to the Virtual Clients, waiting for P2P users to connect to said Virtual Clients for requesting and downloading the content items. Then, each Virtual Client makes an initial handshake with the search facility of the P2P network (such as with the SuperNode in the FastTrack P2P network). At step 530, each Virtual Client gets from Tasks software component 435 (holding all data related to each task) a file representing the content item (such as a song, movie, etc), the name and identifier of said file, metadata, etc. After receiving all data required for sharing one or more content items, each Virtual Client starts offering these items to P2P users. As said, each Virtual Client can share one or more content items, and therefore it gets all data required for sharing said items (such as files identifiers, names of files to be shared over the P2P network, etc.) from Tasks software component 435. For example, if there are 3 content items to be shared over the P2P network and for sharing the first item are required 100 Virtual Clients, for sharing the second—200, and for sharing the third—300, then the first created 100 Virtual Clients will share all 3 content items, the next 100 Virtual Clients will share 2 remaining content items, and the last created 100 Virtual Clients will share the last remaining content item. Task Manager 410 continues creating Virtual Clients until all tasks are distributed among them or Pool of outgoing addresses 427 has no more available addresses for assigning to the Virtual Clients. At step 535, the P2P user searches P2P network for one or more content items, which are shared by a plurality of Virtual Clients 425. The user usually conducts the search by connecting to the P2P network and entering search keywords (such as the name of the song or movie) into his P2P program (such as the eMule, eDonkey™ or Kazaa Light™ program), installed on his computer. When conducting the search, the user gets a list of all network addresses, related to computers that share the content items, along with additional data (such as nicknames, timestamps, etc.). He selects an address (of the Virtual Client) from which he wishes to download one or more content items. His P2P program connects to the listening socket opened by Connection Manager 431 at step 525, and then it makes a handshake with the corresponding Virtual Client. After that at step 540, user's P2P program requests to download files related to said content items, and at step 545, the Virtual Client starts uploading the requested files to user's computer.

It should be noted that system 100 (FIG. 1) of the present invention, can be used either for promoting and retailing of legitimate content items or for suppressing distribution of undesired and copyright-infringing content items. If using system 100 for retailing legitimate content items, then shared files can be DRM-protected copies of music and video files. If using system 100 for suppressing distribution of copyright-infringing content items, then shared files can have meaningless contents (serving as decoys).

While some embodiments of the invention have been described by way of illustration, it will be apparent that the invention can be put into practice with many modifications, variations and adaptations, and with the use of numerous equivalents or alternative solutions that are within the scope of persons skilled in the art, without departing from the spirit of the invention or exceeding the scope of the claims.

1. A system for increasing popularity of one or more content items shared over a peer-to-peer network, comprising:
a. a central server for receiving from an operator terminal by means of a user interface software component a list of said one or more content items to be shared over said peer-to-peer network; and
b. one or more virtual clients servers for communicating with said central server, receiving said list, and increasing popularity of said one or more content items at said peer-to-peer network by creating at least one thousand virtual clients which form a statistical weight sufficient to affect the overall popularity of said one or more content items, each of said virtual clients sharing or pretending to share said one or more content items.

2. System according to claim 1, wherein the central server is provided within the virtual clients server.

3. System according to claim 1, wherein the operator terminal further provides to the central server one or more of the following:
a. a number of virtual clients to be created for sharing each content item within the list;
b. one file for each content item within said list;
c. identifiers of the files; and
d. metadata relating to said each content item.

4. System according to claim 1, wherein the central server further comprises a communication software component for communicating with the virtual clients server.

5. System according to claim 1, wherein the virtual clients server further comprises a geographic locations detection software component for analyzing network addresses of peer-to-peer users who requested to download or downloaded the one or more content items from at least one virtual client, and determining the corresponding geographic locations of said users.

6. System according to claim 1, wherein the central server further receives from the virtual clients server statistical data relating to the process of sharing the one or more content items, said data comprising one or more of the following:
a. a number of peer-to-peer users who downloaded or requested to download said one or more content items;
b. nicknames of said peer-to-peer users;
c. timestamps; and
d. unique identifiers of said peer-to-peer users.

7. System according to claim 5, wherein the central server further receives from the virtual clients server geographic locations of the peer-to-peer users who requested to download or downloaded the one or more content items, for statistical purposes.

8. System according to claim 1, wherein the central server further comprises a search software component for connecting to the peer-to-peer network, searching said network according to a predefined search criteria and determining a number of users sharing the most popular item answering said search criteria.

9. System according to claim 8, wherein the virtual clients server further receives from said search software component said number of users sharing the most popular content item, and further creates a number of virtual clients for sharing the corresponding content item, said number of virtual clients larger or equal to said number of users.

10. System according to claim 1, wherein the central server further comprises a database for storing the list of the one or more content items along with additional data provided by the operator terminal and virtual clients server.

11. System according to claim 10, wherein the central server further comprises a reporting software component for querying the database and generating one or more reports based on the data stored within said database.

12. System according to claim 1, wherein the virtual clients server further comprises a communication manager software component for communicating with the central server.

13. System according to claim 12, wherein the virtual clients server further comprises a task manager software component for creating tasks, according to data provided by the communication manager, said task manager maintaining a list of tasks and creating one or more virtual clients for serving each task.

14. System according to claim 13, wherein the virtual clients server further comprises a tasks software component for holding data related to each task.

15. System according to claim 1, wherein the virtual clients server further comprises a state machines software component for defining the behavior of a virtual client in each peer-to-peer network.

16. System according to claim 1, wherein the virtual clients server further comprises a virtual clients software component for handling the virtual clients that share or pretend to share the one or more content items over the peer-to-peer network.

17. System according to claim 16, wherein each virtual client is connected to a corresponding state machine and operates at any given time according to a corresponding state of said state machine.

18. System according to claim 1, wherein the virtual clients server further comprises a connection manager software component for providing a network address to each virtual client from a pool of outgoing network addresses, said pool provided within said virtual clients server and holding a list of available network addresses.

19. System according to claim 18, wherein the virtual clients server further comprises a configuration manager software component for reading configuration of a peer-to-peer protocol from a protocols configuration software component which holds necessary configuration parameters for each peer-to-peer network, said configuration manager software component conveys said configuration to the connection manager.

20. System according to claim 1, wherein the virtual clients server further comprises a configuration repository for holding the overall configuration of said virtual clients server.

21. System according to claim 1, wherein the virtual clients server further comprises a networking layer for providing network communication services for said virtual clients server.

22. A method for increasing popularity of one or more content items shared over a peer-to-peer network, comprising:
a. providing to a central server by means of an operator terminal using a user interface software component a list of said one or more content items to be shared over said peer-to-peer network; and
b. transferring said list from said central server to one or more virtual clients servers for increasing popularity of said one or more content items at said peer-to-peer network by creating at least one thousand virtual clients which form a statistical weight sufficient to affect the overall popularity of said one or more content items, each of said virtual clients sharing or pretending to share said one or more content items.

23. Method according to claim 22, further comprising providing the central server within the virtual clients server.

24. Method according to claim 22, further comprising providing to the central server by means of the operator terminal one or more of the following:
a. a number of virtual clients to be created for sharing each content item within the list;
b. one file for each content item within said list;
c. identifiers of the files; and
d. metadata relating to said each content item.

25. Method according to claim 22, further comprising providing the central server with a communication software component for communicating with the virtual clients server.

26. Method according to claim 22, further comprising analyzing network addresses of peer-to-peer users who requested to download or downloaded the one or more content items from at least one virtual client, and determining the corresponding geographic locations of said users by means of a geographic locations detection software component provided within the virtual clients server.

27. Method according to claim 22, further comprising providing the central server by means of the virtual clients server with statistical data relating to the process of sharing the one or more content items, said data comprising one or more of the following:
a. a number of peer-to-peer users who downloaded or requested to download said one or more content items;
b. nicknames of said peer-to-peer users;
c. timestamps; and
d. unique identifiers of said peer-to-peer users.

28. Method according to claim 26, further comprising providing the central server by means of the virtual clients server with geographic locations of the peer-to-peer users who requested to download or downloaded the one or more content items, for statistical purposes.

29. Method according to claim 22, further comprising providing the central server with a search software component for connecting to the peer-to-peer network, searching said network according to a predefined search criteria and determining a number of users sharing the most popular item answering said search criteria.

30. Method according to claim 29, further comprising providing the virtual clients server by means of said search software component with said number of users sharing the most popular content item, and further creating a number of virtual clients for sharing the corresponding content item, said number of virtual clients larger or equal to said number of users.

31. Method according to claim 22, further comprising providing the central server with a database for storing the list of the one or more content items along with additional data provided by the operator terminal and virtual clients server.

32. Method according to claim 31, further comprising querying the database by means of a reporting software component provided within the central server and generating one or more reports based on the data stored within said database.
